(19) United States
(12) Patent Application Publication
(10) Pub. No.: US 2015/0269054 A1
(43) Pub. Date: Sep. 24, 2015

(54) Multiple Core Execution Trace Buffer

(71) Applicant: LSI Corporation, San Jose, CA (US)

(72) Inventors: Srinivasa Rao Kothamasu, Bangalore (IN); Romeshkumar Bharatkumar Mehta, Pune (IN)

(73) Assignee: LSI Corporation, San Jose, CA (US)

(21) Appl. No.: 14/217,475

(22) Filed: Mar. 18, 2014

(51) Int. Cl. G06F 11/34

(52) U.S. Cl. CPC G06F 11/3466

(57) ABSTRACT

A data processing system includes a number of processor cores each having a trace interface with an address signal carrying program addresses being executed, a processor core identification circuit connected to the trace interfaces and operable to replace a portion of some of the program addresses with a processor core identification that identifies which of the processor cores provided the program addresses, and an execution trace buffer operable to store the program addresses associated with non-sequential execution in the processor cores. At least some of the program addresses include the processor core identification along with address bits.

### FIELD OF THE INVENTION

Various embodiments of the present invention provide systems and methods for tracing program code execution in a multiple core processor system with a single trace buffer.

### BACKGROUND

Microcontrollers are computers that are typically self-contained systems with processor, memory, and peripherals, and which support real time response to various system events. Microcontrollers are widely used in automobiles, mobiles, consumer products and medical integration etc. Being very small in area and size, they have very limited trace capabilities. For example, ARM® Cortex-M0+ based microcontrollers include a Micro Trace Buffer (MTB) which supports instruction trace capabilities for debugging execution of program code. However, for systems including multiple Cortex-M0+ microcontrollers, there is no shared parallel trace architecture supporting debugging of multiple processor cores.

### SUMMARY

Various embodiments of the present invention provide systems and methods for tracing program code execution in a multiple core processor system with a single trace buffer.

In some embodiments, a data processing system includes a number of processor cores each having a trace interface with an address signal carrying program addresses being executed, a processor core identification circuit connected to the trace interfaces and operable to replace a portion of some of the program addresses with a processor core identification that identifies which of the processor cores provided the program addresses, and an execution trace buffer operable to store the program addresses associated with non-sequential execution in the processor cores. At least some of the program addresses include the processor core identification along with address bits.

This summary provides only a general outline of some embodiments of the invention. The phrases “in one embodiment,” “according to one embodiment,” “in various embodiments”, “in one or more embodiments”, “in particular embodiments” and the like generally mean the particular feature, structure, or characteristic following the phrase is included in at least one embodiment of the present invention, and may be included in more than one embodiment of the present invention. Importantly, such phrases do not necessarily refer to the same embodiment. This summary provides only a general outline of some embodiments of the invention. Additional embodiments are disclosed in the following detailed description, the appended claims and the accompanying drawings.

### BRIEF DESCRIPTION OF THE FIGURES

A further understanding of the various embodiments of the present invention may be realized by reference to the figures which are described in remaining portions of the specification. In the figures, like reference numerals may be used throughout several drawings to refer to similar components. In the figures, like reference numerals are used throughout several figures to refer to similar components.

FIG. 1 depicts a multicore processor system with shared trace memory in accordance with some embodiments of the present invention;

FIG. 2 depicts an interface between a processor core and a multicore trace support circuit in a multicore processor system in accordance with some embodiments of the present invention;

FIG. 3 depicts a multicore processor system with shared trace memory in accordance with some embodiments of the present invention;

FIG. 4 depicts a portion of an identification insertion circuit to combine a processor core identification with an address in accordance with some embodiments of the present invention;

FIG. 5 is a block diagram of an identification insertion circuit to combine a processor core identification with an address in accordance with some embodiments of the present invention; and

FIG. 6 is a flow diagram showing a method for tracing program code execution in a multicore processor system with a single trace buffer in accordance with some embodiments of the present invention.

### DETAILED DESCRIPTION OF THE INVENTION

Embodiments of the present invention are related to tracing program code execution in a multiple core processor system with a single execution trace buffer. The trace buffer is shared by the multiple processor cores, providing non-invasive debugging for multiple cores without greatly increasing size and power consumption. The multiple core execution trace buffer is not limited to use with any particular type of processor cores. In some embodiments, the processor cores comprise ARM® Cortex-M0+ based microcontrollers. In these embodiments, a single Micro Trace Buffer (MTB) is shared by the multiple processor cores, with processor core identifications (IDs) being inserted into either the source or destination addresses for branches before the Micro Trace Buffer stores them. When a debugger or trace port analyzer then accesses the traces stored in the Micro Trace Buffer, the identifications can be used to associate each trace with the processor core in which the program code was executed.

The multiple core execution trace buffer provides parallel execution tracing for multiple core processor systems, without multiplying the area and power requirements for handling the trace data, whether multiple processor cores are simultaneously executing the same or different program code. In some embodiments, the multiple core execution trace buffer supports trace source identification through higher or most significant bits of branch addresses that are stored by the execution trace buffer. In some embodiments, when the number of address bits that can be used for processor core identifications and branch addresses is limited, the multiple core execution trace buffer provides compressed address decoding for reuse of higher order address bits for trace source identification.

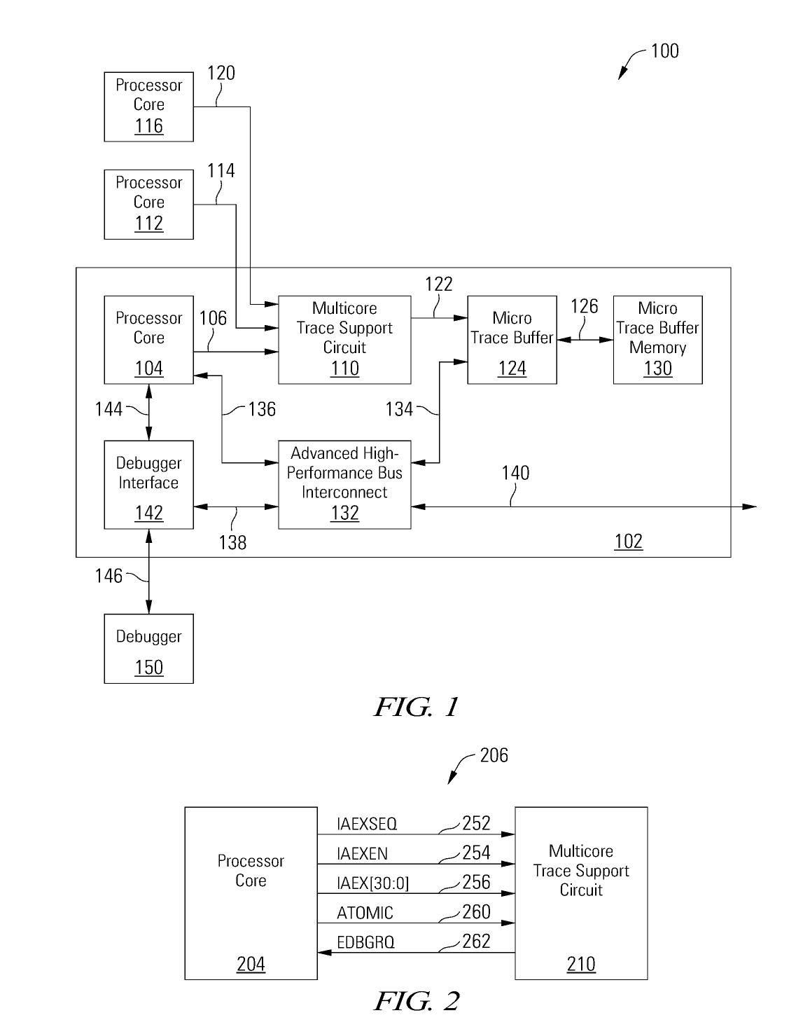

Turning to FIG. 1, a multicore processor system 100 with shared trace memory is depicted in accordance with some embodiments of the present invention. A single core cell 102 with multicore trace support includes a single processor core 104, with a single Micro Trace Buffer 124. Additional processor cores 112, 116 share the single Micro Trace Buffer 124, enabling debugging in the multicore processor system 100 without multiplying the execution trace circuitry. Although the multicore processor system 100 is not limited to use with any particular type of processor core, in some embodiments, the processor cores 104, 112, 116 comprise ARM® Cortex-M0+ based microcontrollers. The processor cores 104, 112, 116 can be operated at a single synchronous frequency, or asynchronously to each other.

A multicore trace support circuit 110, also referred to herein as a processor core identification circuit, receives a trace interface signal 106, 114, 120 from each of the processor cores 104, 112, 116. The trace interface signals 106, 114, 120 carry, among other things, the address in the program code being executed immediately before and after branches. In other words, each time the program code being executed by processor cores 104, 112, 116 jumps to a location that is not sequential, the pair of addresses before and after the jump are provided by the trace interface signals 106, 114, 120 to the multicore trace support circuit 110. Such a pair of source and destination addresses is referred to herein as a trace packet.

When the multicore trace support circuit 110 receives the source and destination addresses, it inserts the processor core identification of the processor core 104, 112, or 116 from which the source and destination addresses were received. The processor core identification is inserted either into the source or destination address in some embodiments, replacing the upper or most significant bits of the address. The upper address bits are replaced by the processor core identification in such a manner that the complete source and destination addresses can be reconstructed by a debugger 150.

The multicore trace support circuit 110 generates a single trace output 122 that contains, in some embodiments, the same information as in trace interface signals 106, 114, 120, but with the processor core identification inserted into each trace packet. The single trace output 122 is provided to a Micro Trace Buffer 124, or more generally, to a program execution trace handling circuit that determines what trace data 126 should be stored in a memory such as a Micro Trace Buffer memory 130. In some embodiments, the Micro Trace Buffer memory 130 comprises a static random access memory (SRAM). The trace data with processor core identification inserted into each trace packet can be stored in the Micro Trace Buffer memory 130 in any suitable format and order. The trace data from multiple processor cores 104, 112, 116 can be intermixed and later separated and ordered in a debugger 150, or can in some embodiments be separated and ordered in the Micro Trace Buffer memory 130 by the Micro Trace Buffer 124. Based upon the disclosure provided herein, one of ordinary skill in the art will recognize a variety of circuits and configurations that can be used to receive and store program execution trace data from the multicore trace support circuit 110.

The single processor core 104 has a connection 144 with a debugger interface 142, which in some embodiments comprises, but is not limited to, an Advanced High-Performance bus access port (AHB-AP) or debug access port (DAP) which can provide access to all memory and registers in the system, including processor registers, and particularly including trace data stored in the Micro Trace Buffer memory 130, via the Micro Trace Buffer 124. An external debugger 150 can be connected to the debugger interface 142 to control the single processor core 104, and in some embodiments, the other processor cores 112, 116, and to access the trace data from the Micro Trace Buffer 124. The connection 146 between the debugger 150 and the single core cell 102 can comprise any suitable type of connection, such as, but not limited to, a Joint Test Action Group (JTAG), Serial Wire (SW) and/or Debug Access Port (DAP) connection. The debugger 150 can be any suitable device for controlling and debugging the single core cell 102 including retrieving the trace data from the Micro Trace Buffer memory 130 through the Micro Trace Buffer 124, such as, but not limited to, a hardware debugging circuit board and/or general purpose computer programmed with debugging software. Based upon the disclosure provided herein, one of ordinary skill in the art will recognize a variety of debuggers and debugging interfaces that can be used.

The single processor core 104 is connected to other peripherals in some embodiments by an interconnect circuit, such as, but not limited to, an Advanced High-Performance (AHB) bus interconnect 132. The bus interconnect 132 can have a connection 136 with the single processor core 104, a connection 134 with the Micro Trace Buffer 124, a connection 140 with external peripherals such as, but not limited to, system memory (not shown) or other functional peripherals, and a connection 138 with the debugger interface 142. In some embodiments, the trace data is accessed by the debugger 150 through the debugger interface 142, the processor core 104, the bus interconnect 132, the Micro Trace Buffer 124, and the Micro Trace Buffer memory 130 where it is stored.

Turning to FIG. 2, the interface 206 between a processor core 204 and a multicore trace support circuit 210 in a multicore processor system is depicted in accordance with some embodiments of the present invention, such as in an embodiment using an ARM® Cortex-M0+ processor core 104. An IAEXSEQ signal 252, which indicates that the next instruction address in the IAEX signal 256 is sequential, that is, non-branching. During an execution trace, generally only the pair of addresses before and after a jump are stored in the Micro Trace Buffer memory 130 by the Micro Trace Buffer 124 as a trace packet, although in some cases other addresses can also be stored, such as at the start of a trace operation, or as commanded by the single processor core 104. The IAEXSEQ signal 252 is used by the Micro Trace Buffer 124 to identify addresses that should be stored in Micro Trace Buffer memory 130. An IAEXEN signal 254 is an IAEX register enable that indicates when the address on the IAEX signal 256 is valid and can be read. The IAEX[30:0] signal 256 carries the registered address of the instruction in the execution stage, shifted right by one bit. An ATOMIC signal 260 indicates the processor core 104 is performing branches due to non-regular transaction flow like exceptions. An EDBGRQ signal 262 enables the Micro Trace Buffer 124 to request that the single processor core 104 enter the debug state.

Based on the information carried by the trace interface signal 106, the multicore trace support circuit 110 and Micro Trace Buffer 124 generates the trace data to be stored in the Micro Trace Buffer memory 130. This trace data, as it would appear without processor core identification supporting multiple core execution tracing, is shown in Table 1:

TABLE 1

| | |
|---|---|
| Mem | |
| Addr | Trace Data |

| | | |
|---|---|---|
| 2N-1 | Nth Destination Address | S |
| 2N-2 | Nth Source Address | A |
| 3 | 2nd Destination Address | S |
| 2 | 2nd Source Address | A |
| 1 | 1st Destination Address | S |
| 0 | 1st Source Address | A |

The trace data includes only non-sequential transaction flow, such as branches, exceptions, and trace starts. Trace data comprises a list of trace pairs, including the source address immediately before a jump and the destination address of the jump. Thus, for each non-sequential flow change, two memory locations will be allocated in Micro Trace Buffer memory 130. In some embodiments, each trace data entry consists of 32 bits, of which 31 bits correspond to trace addresses [31:1] and 1 bit of trace control information, represented as an A bit for source addresses and an S bit for destination addresses. The A bit is used before a jump and denotes the atomic state of the branch, whether the branch was caused by instruction flow or an exception. The A bit is derived from the ATOMIC signal 260. The S bit applied to destination addresses indicates the start packet of a trace flow, with a value of 1 indicating where the first packet after the trace started and a value of 0 used for other packets.

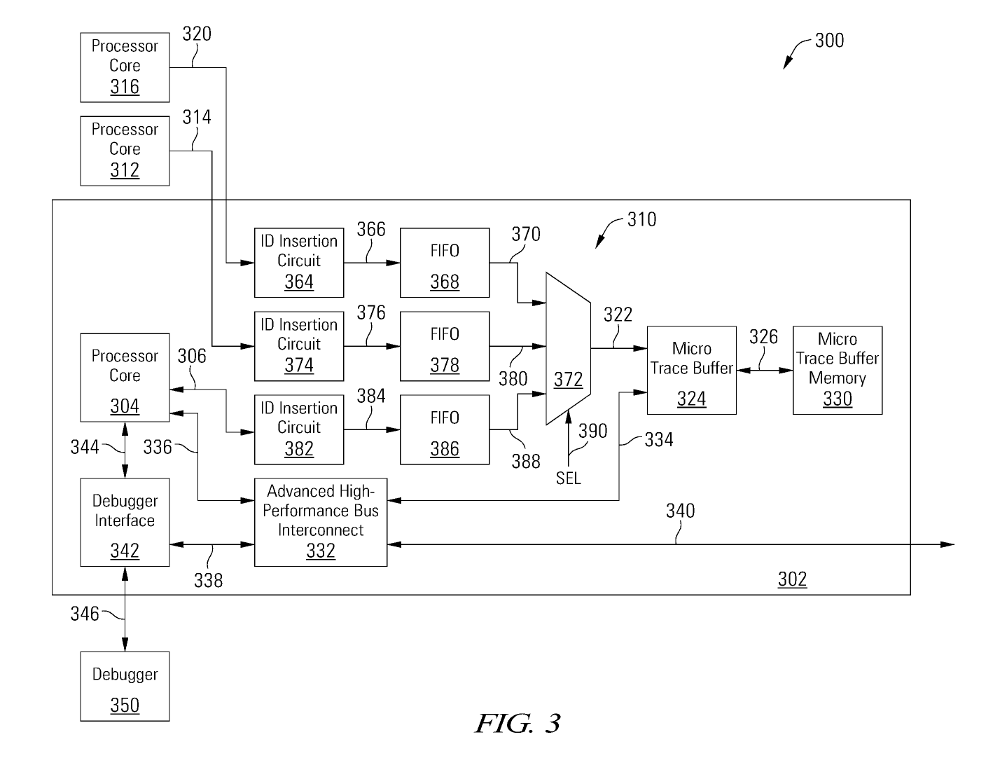

Turning to FIG. 3, a multicore processor system 300 with shared trace memory is depicted in accordance with some embodiments of the present invention. In this embodiment, a multicore trace support circuit 310 includes an identification insertion circuit 364, 374, 382 for each processor core 304, 312, 316 to replace upper bits of either source or destination addresses in trace packets with processor core identification information. The multicore trace support circuit 310 also includes first-in first-out (FIFO) memories/buffers 368, 378, 386 to store trace packet data. Trace packet data includes information provided by trace interface 206, and processor core identification inserted into either source or destination addresses. An arbiter circuit 372 routes the trace packets from the memories 368, 378, 386 to the Micro Trace Buffer 324 to be stored in Micro Trace Buffer memory 330.

A single core cell 302 with multicore trace support includes a single processor core 304, with a single Micro Trace Buffer 324. Additional processor cores 312, 316 share the single Micro Trace Buffer 324, enabling debugging in the multicore processor system 300 without multiplying the execution trace circuitry. Although the multicore processor system 300 is not limited to use with any particular type of processor core, in some embodiments, the processor cores 304, 312, 316 comprise ARM® Cortex-M0+ based microcontrollers.

The identification insertion circuits 364, 374, 382 in the multicore trace support circuit 310 receive the trace interface signals 306, 314, 320 from each of the processor cores 304, 312, 316 and insert the processor core identification into either the source or destination addresses around each jump. The trace interface signals 366, 376, 384 with the identification information are stored in memories 368, 378, 386. The arbiter 372, under control of a select signal 390, reads the stored trace interface signals 370, 380, 388 from the memories 368, 378, 386, aggregating or interleaving them to yield the single trace signal 322 provided to Micro Trace Buffer 324. In some embodiments, the memories 368, 378, 386 comprise asynchronous first-in first-out memories. In some embodiments, the arbiter 372 selects the stored trace interface signals 370, 380, 388 based on the availability of data in the memories 368, 378, 386, or based on the free space in the memories 368, 378, 386, or in any other suitable manner, such as, but not limited to, a round robin scheme or priority-based scheme. In some embodiments, the select signal 390 is derived in the arbiter 372 based on the selected arbitration scheme. Based upon the disclosure provided herein, one of ordinary skill in the art will recognize a variety of arbiter circuits suitable to accept stored trace interface signals 370, 380, 388 from the memories 368, 378, 386 and to multiplex them to yield the single trace signal 322.

The single trace signal 322 is provided to a Micro Trace Buffer 324, or more generally, to a program execution trace handling circuit that determines what trace data 326 should be stored in a memory such as a Micro Trace Buffer memory 330. In some embodiments, the Micro Trace Buffer memory 330 comprises a static random access memory (SRAM). The trace data with processor core identification inserted into each trace packet can be stored in the Micro Trace Buffer memory 330 in any suitable format and order. The trace data from multiple processor cores 304, 312, 316 can be intermixed and later separated and ordered in a debugger 350, or can in some embodiments be separated and ordered in the Micro Trace Buffer memory 330 by the Micro Trace Buffer 324. Based upon the disclosure provided herein, one of ordinary skill in the art will recognize a variety of circuits and configurations that can be used to receive and store program execution trace data from the multicore trace support circuit 310.

The single processor core 304 has a connection 344 with a debugger interface 342, which in some embodiments comprises an Advanced High-Performance bus access port (AHB-AP) or debug access port (DAP) which can provide access to all memory and registers in the system, including processor registers, and particularly including trace data stored in the Micro Trace Buffer memory 330, via the Micro Trace Buffer 324. An external debugger 350 can be connected to the debugger interface 342 to control the single processor core 304, and in some embodiments, the other processor cores 312, 316, and to access the trace data from the Micro Trace Buffer memory 330 through the Micro Trace Buffer 324. The connection 346 between the debugger 350 and the single core cell 302 can comprise any suitable type of connection, such as, but not limited to, a Joint Test Action Group (JTAG), Serial Wire (SW) and/or Debug Access Port (DAP) connection. The debugger 350 can be any suitable device for controlling and debugging the single core cell 302 including retrieving the trace data from the Micro Trace Buffer memory 330 through the Micro Trace Buffer 324, such as, but not limited to, a hardware debugging circuit board and/or general purpose computer programmed with debugging software. Based upon the disclosure provided herein, one of ordinary skill in the art will recognize a variety of debuggers and debugging interfaces that can be used.

The single processor core 304 is connected to other peripherals in some embodiments by an interconnect circuit, such as, but not limited to, an Advanced High-Performance (AHB) bus interconnect 332. The bus interconnect 332 can have a connection 336 with the single processor core 304, a connection 334 with the Micro Trace Buffer 324, a connection 340 with external peripherals such as, but not limited to, system memory (not shown), and a connection 338 with the debugger interface 342. In some embodiments, the trace data is accessed by the debugger 350 through the debugger interface 342, the processor core 304, the bus interconnect 332, the Micro Trace Buffer 324, and the Micro Trace Buffer memory 330 where it is stored.

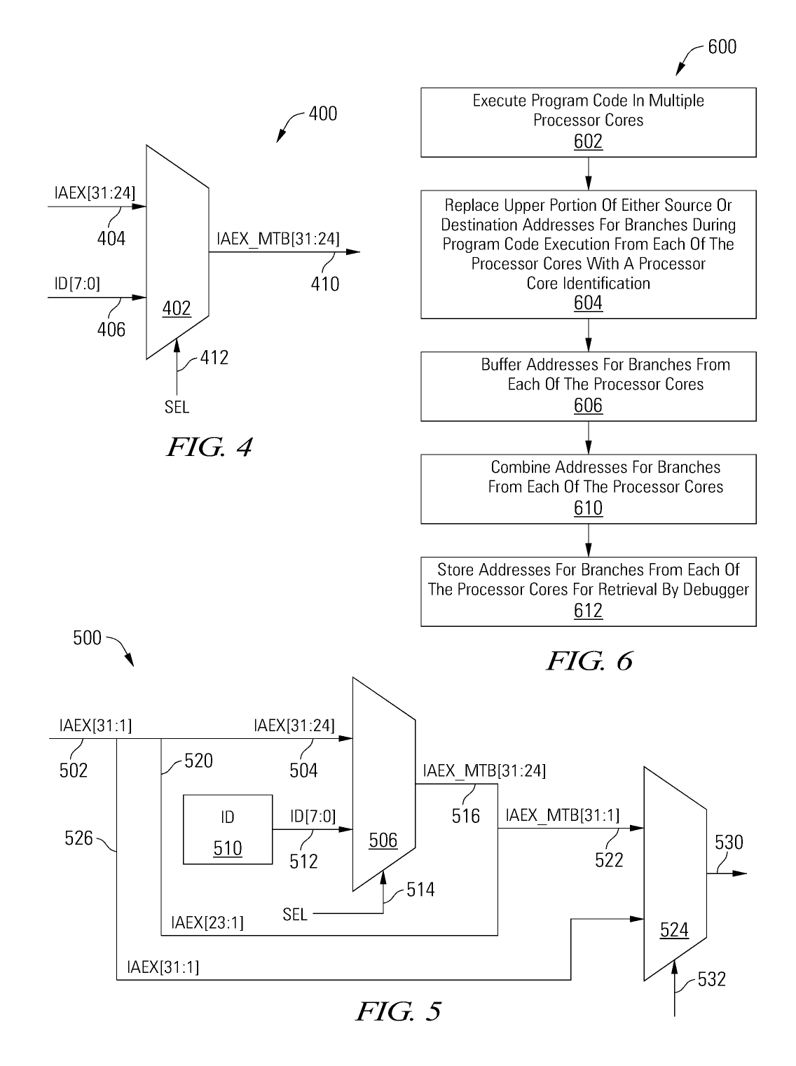

Turning to FIG. 4, a portion 400 of an identification insertion circuit to combine a processor core identification with an address is depicted in accordance with some embodiments of the present invention. A multiplexer 402 receives the upper address bits in an IAEX[31:24] signal 404 derived from a trace interface signal (e.g., 106), and a processor identification signal ID[7:0] 406. Based upon the state of a select signal 412, the multiplexer 402 outputs an IAEX_MTB[31:24] signal 410 that contains either the upper address bits from IAEX[31:24] signal 404 or processor identification signal ID[7:0] 406. The select signal 412 is derived in some embodiments from various signals in the trace interface signal (e.g., 106) that identify when a processor core (e.g., 104) has executed a branch address, such as the IAEXSEQ signal 252 and IAEXEN signal 254 the indicate that a non-sequential program counter change during program execution.

The width of the processor identification signal ID[7:0] 406 and of the IAEX[31:24] signal 404 to the 8 bits of the example. In this case, the 8-bit processor identification signal ID[7:0] 406 supports parallel execution tracing in up to 256 processor cores. However, the width of the processor identification signal ID[7:0] 406 and of the IAEX[31:24] signal 404 can be adjusted to accommodate different numbers of processor cores sharing the execution trace circuitry.

In some embodiments, the value of the processor identification signal ID[7:0] 406 is hard-wired. In some other embodiments, the processor identification signal ID[7:0] 406 can be dynamically programmed, for example using an external debugger (e.g., 150) and/or by program code executed by one of the processor cores (e.g., 104).

Turning to FIG. 5, an identification insertion circuit 500 to combine a processor core identification with an address is depicted in accordance with some embodiments of the present invention. The identification insertion circuit 500 includes a multiplexer 506 that receives the upper address bits in an IAEX[31:24] signal 504 extracted from an IAEX[31:1] address signal 502. The multiplexer 506 also receives a processor identification signal ID[7:0] 512 from a programmable identification register 510 or hard-wired processor identification circuit. Based upon the state of a select signal 514, the multiplexer 506 outputs an IAEX_MTB[31:24] signal 516 that contains either the upper address bits from IAEX[31:24] signal 504 or processor identification signal ID[7:0] 512. The select signal 514 is derived in some embodiments from various signals in the trace interface signal (e.g., 106) that identify when a processor core (e.g., 104) has executed a branch address, such as the IAEXSEQ signal 252 and IAEXEN signal 254 the indicate that a non-sequential program counter change during program execution. The IAEX_MTB[31:24] signal 516 is combined with an IAEX[23:1] signal 520 to yield an IAEX_MTB[31:1] signal 522 which contains the branch address with the processor core identification. A multiplexer 524 can be used to select either the IAEX_MTB[31:1] signal 522 which contains the branch address with the processor core identification or the original IAEX[31:1] address signal 526 without processor core identification based upon a select signal 532, yielding an output 530. As will be described in more detail below, the processor core identification can be inserted into either the source or destination address of branches. Based upon the disclosure provided herein, one of ordinary skill in the art will recognize a variety of circuits that can be used to replace a portion of either the source or destination address of branch operations with a processor core identification.

Again, the number of bits in the processor core identification and program code addresses are not limited to the examples disclosed herein, and can be adjusted based on the particular system requirements, such as the number of processor cores. Generally, the unused bits of either source or destination addresses of branches are used to store the processor core identification. In some embodiments, as will be disclosed in more detail below, where some used address bits are replaced by the processor core identification, they are replaced in such a manner that the complete branch addresses can be precisely reconstructed later in the debugger or elsewhere.

For example, microcontrollers used in an embedded system to perform standalone tasks often have programs with very small footprint or size, typically under 1 MB. In such cases, branch addresses, or the offsets between source and destination addresses, will only use 19 bits, bits [19:1], in a 16-bit aligned system. In such a system, the upper 10+bits [31:20] of a 32-bit system can be used for trace source identification. Architectural parameters can also control the number of bits available for use in trace source identification while retaining the ability to precisely reconstruct complete source and destination addresses of branches. For example, in a system with ARM® Cortex-M0+ processor cores using a Thumb/Thumb2 architecture, branch instructions B, BL (immediate), and BLX (immediate) support up to maximum of 16 MB branch target addresses, using 24 bits to address and leaving 8 bits available for core identification.

Again, the processor core identification can replace the upper bits of either source or destination addresses of branches. The trace data format with processor core identification replacing source address upper bits is shown in Table 2 in accordance with some embodiments:

TABLE 2

| Mem | |
|---|---|
| Addr | Trace Data |
| 2N-1 | Nth Destination Address |

| | | |
|---|---|---|
| 2N-2 | IDN | Nth Source Address |

| | |
|---|---|
| 3 | 2nd Destination Address |

| | | |
|---|---|---|
| 2 | ID2 | 2nd Source Address |

| | |
|---|---|
| 1 | 1st Destination Address |

| | | |
|---|---|---|
| 0 | ID1 | 1st Source Address |

The trace data is stored in trace packets each having a pair of addresses, the source address with the upper bits replaced by the processor core identification, and the destination address corresponding to a non-sequential pair of operations in the identified processor core. The trace data format with processor core identification replacing destination address upper bits is shown in Table 3 in accordance with some embodiments:

TABLE 3

| | |
|---|---|
| Mem | |
| Addr | Trace Data |

| | | |
|---|---|---|
| 2N-1 | IDN | Nth Destination Address |

| | |
|---|---|
| 2N-2 | Nth Source Address |

| | | |
|---|---|---|
| 3 | ID2 | 2nd Destination Address |

| | |
|---|---|
| 2 | 2nd Source Address |

| | | |
|---|---|---|
| 1 | ID1 | 1st Destination Address |

| | |
|---|---|
| 0 | 1st Source Address |

Again, the trace data is stored in trace packets each having a pair of addresses, the source address of a branch and the destination address with the upper bits replaced by the processor core identification, corresponding to a non-sequential pair of operations in the identified processor core.

In some embodiments, the debugger reconstructs the complete source or destination address. For example, in the system described above with ARM® Cortex-M0+ processor cores using a Thumb/Thumb2 architecture, branch instructions support up to maximum of 16 MB branch target addresses, using 24 bits to address. With an 8-bit processor core identification supporting up to 256 processor cores, one of the branch addresses is reconstructed based on the other branch address in a trace packet. In an embodiment in which processor core identification replaces upper source address bits, there will be a 32-bit source address and a 24-bit destination address. If the processor executes a branch with a source address of 0x4580_{—}0000 and a destination address of 0x4680_{—}0000, the 32-bit source address will be 0x4580_{—}0000, and the 24-bit destination address (the lower 24 bits) will be 0x80_{—}0000. The complete 32-bit destination address can be reconstructed based on the source address as Destination address[31:24]=source address[31:24]+(destination address[23:1]==source address[23:1])?1′b1:1′b0. In other words, the upper 8 bits of the destination address are replaced by the upper 8 bits of the source address, plus 1 if the lower 24 bits of the destination address and source address are identical, i.e. 0x45+1=0x46. This reconstruction technique is based on the fact that in this embodiment, the largest jump that is supported is 16 MB, using 24 address bits ([23:0]). If the largest possible jump is taken, the 24th bit is calculated by adding +1 to the previous base address, effectively adding +1 to bits [31:24] of the base address.

Similarly, in an embodiment in which processor core identification replaces upper destination address bits, there will be a 24-bit source address and a 32-bit destination address. Given the same example branch, the 24-bit source address (the lower 24 bits) will be 0x80_{—}0000, and the 32-bit destination address will be 0x4580_{—}0000. The complete 32-bit source address can be reconstructed based on the destination address as Source address[31:24]=destination address [31:24]−(destination address [23:1]==source address [23:1])? 1′b1:1′b0. In other words, the upper 8 bits of the source address are replaced by the upper 8 bits of the destination address, minus 1 if the lower 24 bits of the source address and destination address are identical, i.e. 0x46−1=0x45.

Other packet formats are used in some embodiments. In some embodiments, multiple processor core identification formats can coexist, with the processor core identification replacing source address bits in some cases and replacing destination address bits in other cases, as shown in Table 4:

TABLE 4

| | |
|---|---|
| Mem | |
| Addr | Trace Data |

| | | |
|---|---|---|
| 2N-1 | IDN | Nth Destination Address |

| | |
|---|---|
| 2N-2 | Nth Source Address |
| 3 | 2nd Destination Address |

| | | |
|---|---|---|
| 2 | ID2 | 2nd Source Address |
| 1 | ID1 | 1st Destination Address |

| | |
|---|---|
| 0 | 1st Source Address |

Furthermore, addresses can be represented in any suitable manner in any of these or other trace data formats, such as, but not limited to, absolute or relative addresses. In some embodiments, destination addresses are given as an offset to the corresponding source address. In some embodiments, source addresses are given as an offset to the corresponding destination address.

In the case of exceptions, the exception destination address is dedicated and is on the order of 256 locations (0x0 to 0xFF) in some embodiments. In these cases, the trace data need not capture all upper bits of the destination address. For example, if an IRQ exception occurs when a processor is executing an instruction at 0xCABC_DEF0, the processor jumps to a destination address 0x0000_{—}001C. In this case the trace capturing model can restrict capturing only lower address bits (e.g., the lower 24 bits) as follows:

Source address [31:1]=0x655E_{—}6F79 ((0xCABC_DEF0+2)/2) (return address)

Destination address [23:1]=0x00_{—}000E (0x1C/2)

The destination exception address can be qualified using atomic bit A to determine whether an exception occurred rather than a program branch. For exceptions, the upper 8 bits of the destination address can be used for processor core identification.

Turning to FIG. 6, a flow diagram 600 shows a method for tracing program code execution in a multicore processor system with a single trace buffer in accordance with some embodiments of the present invention. Following flow diagram 600, program code is executed in multiple processor cores. (Block 602) The upper portion of either source or destination addresses for branches during program code execution from each of the processor cores is replaced with a processor core identification. (Block 604) Trace packets containing addresses for branches from each of the processor cores are buffered, such as in FIFOs, either synchronous or asynchronous. (Block 606) The trace packets from each of the processor cores are combined, such as in an arbiter. (Block 610) The addresses for branches from each of the processor cores are stored for retrieval by a debugger. (Block 612)

It should be noted that the various blocks shown in the drawings and discussed herein can be implemented in integrated circuits along with other functionality. Such integrated circuits can include all of the functions of a given block, system or circuit, or a subset of the block, system or circuit. Further, elements of the blocks, systems or circuits can be implemented across multiple integrated circuits. Such integrated circuits can be any type of integrated circuit known in the art including, but are not limited to, a monolithic integrated circuit, a flip chip integrated circuit, a multichip module integrated circuit, and/or a mixed signal integrated circuit. It should also be noted that various functions of the blocks, systems or circuits discussed herein can be implemented in either software or firmware. In some such cases, the entire system, block or circuit can be implemented using its software or firmware equivalent. In other cases, the one part of a given system, block or circuit can be implemented in software or firmware, while other parts are implemented in hardware.

In conclusion, the present invention provides novel systems and methods for tracing program code execution in a multiple core processor system with a single trace buffer. While detailed descriptions of one or more embodiments of the invention have been given above, various alternatives, modifications, and equivalents will be apparent to those skilled in the art without varying from the spirit of the invention. Therefore, the above description should not be taken as limiting the scope of the invention, which is defined by the appended claims.

What is claimed is:

1. A data processing system comprising:
a plurality of processor cores each comprising a trace interface with an address signal carrying program addresses being executed;
a processor core identification circuit connected to the trace interfaces and operable to replace a portion of some of the program addresses with a processor core identification that identifies which of the plurality of processor cores provided the program addresses; and
an execution trace buffer operable to store the program addresses associated with non-sequential execution in the plurality of processor cores, wherein at least some of the program addresses comprise the processor core identification along with address bits.

2. The data processing system of claim 1, wherein the processor core identification circuit is operable to replace a portion of source addresses executed before a jump with the processor core identification.

3. The data processing system of claim 1, wherein the processor core identification circuit is operable to replace a portion of destination addresses executed after a jump with the processor core identification.

4. The data processing system of claim 1, wherein the processor core identification circuit is operable to replace unused upper address bits with the processor core identification.

5. The data processing system of claim 1, wherein the processor core identification circuit comprises a multiplexer operable to selectably output either a subset of address bits in the program addresses or the processor core identification.

6. The data processing system of claim 1, wherein the processor core identification is hardwired in the processor core identification circuit.

7. The data processing system of claim 1, wherein the plurality of processor cores comprise ARM Cortex-M0+ microcontroller cores.

8. The data processing system of claim 1, wherein the processor core identification circuit comprises a trace interface input for each of the plurality of processor cores.

9. The data processing system of claim 1, wherein the execution trace buffer comprises a single trace interface input connected to the processor core identification circuit.

10. The data processing system of claim 1, wherein the processor core identification circuit comprises an identification insertion circuit for each of the plurality of processor cores, each connected to one of the trace interfaces, operable to replace said portion of some of the program addresses with the processor core identification that identifies which of the plurality of processor cores provided the program addresses.

11. The data processing system of claim 10, wherein the identification insertion circuits comprise multiplexers operable to selectably output either a subset of address bits in the program addresses or the processor core identification.

12. The data processing system of claim 10, wherein the processor core identification circuit comprises an asynchronous first-in first-out memory connected to outputs of each of the identification insertion circuits.

13. The data processing system of claim 1, wherein the execution trace buffer comprises a Micro Trace Buffer and a Micro Trace Buffer Memory.

14. The data processing system of claim 1, further comprising a dynamically programmable processor core identification register for each of the plurality of processor cores, wherein the processor core identification circuit is operable to access the processor core identification registers.

15. A method for debugging a multiple processor core system, comprising:
executing program code in multiple processor cores;
replacing a portion of at least some branch addresses in the program code with processor core identifications identifying which of the multiple processor cores executed the program code; and
storing branch addresses in the program code in a trace buffer.

16. The method of claim 15, further comprising retrieving the branch addresses from the trace buffer with a debugger.

17. The method of claim 16, further comprising separating the branch addresses by processor core based on the processor core identifications.

18. The method of claim 16, further comprising reconstructing complete addresses in the branch addresses that include processor core identifications, based on the branch addresses that do not include processor core identifications.

19. The method of claim 15, wherein replacing the portion of at least some branch addresses in the program code with processor core identifications comprises replacing unused upper address bits in the branch addresses with the processor core identifications.

20. A multiple processor core debugging system comprising:
a plurality of processor cores;
a multicore trace support circuit operable to receive addresses of programs as they are executed in the plurality of processor cores and to insert processor core identifications into at least some of the addresses;
a trace buffer operable to store non-sequential ones of the addresses; and
a debugger connected to at least one of the plurality of processor cores and operable to retrieve the non-sequential ones of the addresses from the trace buffer and to separate trace information by processor core based on the processor core identifications.
